(19) United States
(12) Patent Application Publication
(10) Pub. No.: US 2013/0118352 A1
(43) Pub. Date: May 16, 2013

(54) Air Extraction Device and Method for Removing Particles Carried by an Air Stream

(71) Applicant: Udo Berling, Hopsten (DE)

(72) Inventor: Udo Berling, Hopsten (DE)

(73) Assignee: BERLING GMBH, Hopsten (DE)

(21) Appl. No.: 13/582,443

(22) PCT Filed: Mar. 2, 2011
(86) PCT No.: PCT/EP2011/001026

§ 371 Date: Nov. 13, 2012

(30) Foreign Application Priority Data
Mar. 4, 2010 (DE) 10 2010 010 307.1
Dec. 3, 2010 (DE) 10 2010 053 215.0

(51) Int. Cl. B01D 45/14

(52) U.S. Cl. CPC B01D 45/14
USPC 95/270; 55/405; 55/401

(57) ABSTRACT

The invention relates to an air extraction device (2) comprising an intake opening (4), a downstream air duct for an air flow (L), said air duct extending in a first section through a rotatingly driven fan wheel (6) radially outward and extending in a second section downstream of the outlet openings (5) of the fan wheel (6) such that the air flow (L) is deviated in an approximately axial direction to the fan wheel (6), and runs into an exhaust opening (8). The second section has a lateral wall (10) that is arranged opposite to the outlet openings (5) of the fan wheel (6) at a distance thereto. The aim of the invention is to improve the capacity of the air extraction device. For this purpose, the second section comprises a through-flow compartment (12) arranged in the plane of rotation of the fan wheel (6) which compartment is arranged downstream of the outlet openings (5) of the fan wheel (6), which is radially limited by the lateral wall (10) and in which no air guideways are arranged.

The present invention concerns an air extraction device with an intake opening, an air guiding passage for an air flow adjoining the intake opening and embodied so as to extend with a first section through a rotatingly drivable fan wheel in radial direction outwardly and with a second section, adjoining the outflow openings of the fan wheel, with deflection of the air flow in an approximately axial direction relative to the fan wheel and so as to end in a blow-out opening, wherein the fan wheel is designed such that the second section has a lateral wall positioned at a spacing opposite to the outflow openings of the fan wheel.

The invention also relates to a method for removing particles that are moved within an air flow, in which method the air flow is conveyed in radial direction through a fan wheel and accelerated, exits from the outflow openings from the fan wheel, and is subsequently deflected in an axial direction.

An air extraction device of the aforementioned kind as well as a method of the aforementioned kind are disclosed in publication WO 2009/056207. In this publication, guide vanes that are immediately downstream of the fan wheel are disclosed by means of which the air flow that is exiting from the fan wheel is slowed down and in this way a separation of the particles moved within the air flow is realized in that they impinge on the surfaces of the guide vanes and adhere thereto. This device provides acceptable separation results; however, a relatively high blower power is required and the running noise is clearly audible.

It is the object of the present invention to improve the known air extraction device as well as the known method.

The object is solved by an air extraction device of the aforementioned kind in which the second section has a flow-through space that is arranged in the plane of rotation of the fan wheel, that adjoins the outflow openings of the fan wheel, that is delimited in radial direction by the lateral wall, and in which no air guiding devices are arranged.

The object is solved for a method of the aforementioned kind in that the deflection in an axial direction is realized in a flow-through space that adjoins the outflow openings, that in radial direction is delimited by a lateral wall that is arranged at a spacing to the outflow openings and is free of air guiding devices that cause an air deflection other than in axial direction of the fan wheel.

With the design according to the invention the air flow that is exiting from the fan wheel is not slowed down by deflections into a direction other than the axial direction but can flow unhindered with full speed into the flow-through space. By the deflection of the air flow in the flow-through space from the radial into an at least approximately axial direction along the lateral wall, by means of which the deflection is effected, removal of the particles such as oils, grease, condensation and the like floating within the air flow from the air that is being moved with the air flow is realized. For the invention, it is no necessary that the air flow is mandatorily deflected precisely in axial direction, it is sufficient to provide deflection into an approximately axial direction. An air flow that is approximately deflected still in axial direction is to be understood as an air flow that after deflection deviates with its flow direction by up to 20 degrees from the axial direction.

According to the invention, the air flow must also not be guided into a single blow-out opening; it is also possible to provide several blow-out openings. Also, it should be noted that the air extraction device must not mandatorily be arranged like a range hood or an extraction device for an air conditioning device at an end of an air passage; instead, the air extraction device can also be integrated into a section of a pipe system and, for example, can be inserted into a pipe section.

While the low-density air can align itself at a smaller radius relative to the new movement direction, the particles that are moved within the air flow because of their higher density require a greater radius. The greater the flow speed of the air flow that is exiting from the fan wheel, the greater the difference in the radius of the air and the particles moved within the air flow. Because of the greater radius and the increased flow speed, most of the particles that are moved in the airflow collide with the surface of the lateral wall and adhere thereto. Accordingly, these particles are removed from the air flow. Because of the higher flow speed in the area of the through-flow space, even more improved separation efficiencies can be achieved. In this connection, the power consumption upon operation of the air extraction device according to the invention is smaller than that of the device known from the prior art and the noise development is lower. Also, a smaller volume flow of air is required.

For the purposes of the invention it is sufficient to employ a fan wheel that is optimized for the application, wherein the rotational speed and the shape and ejection direction of the vanes and the size and shape of the flow-through space are matched to each other such that a great constant performance range of the air extraction device results. When in this description reference is being had to axial or radial direction, this always refers to the axis of rotation of the fan wheel.

The flow-through space according to one embodiment of the invention can adjoin immediately the outflow openings. Because of the immediate connection, the air flow reaches with its highest flow speed from the outflow openings of the fan wheel directly the flow-through space. The high flow speed can then be fully utilized in order to obtain a separation of the different components of the components moved within the air flow by deflection and the different density of the gas and grease particles within the air flow and the thus resulting different trajectories. The faster a particle is moving within an air flow in one direction, the greater the forces that must be applied in order to change the flow direction of this particle. Also, the heavier a particle, the greater the forces that must be applied in order to change the flow direction of the particle. Based on the combination of movement speed and weight of the particle, for each particle an individual trajectory in the deflection area results that, for greater flow speeds for the respective particles is further spread apart. With greater spreading also improved separation can be obtained. The immediate connection of the flow space to the outflow openings results in an improved separation effect because the flow speed of the air flow and of the particles conveyed therein for an immediate connection of the flow-through space to the outflow openings of the fan wheel is not reduced or only minimally reduced.

According to one embodiment of the invention, the lateral wall has one or several openings through which the substances that are gliding and/or flowing along the wall can reach the back of the wall. Accordingly, the substances that are gliding and/or flowing along the wall are removed completely from the flow-through space and cannot be entrained again by the air flow or cannot reach the downstream air guiding passages where they present a fire risk, cause unpleasant odors, or may attract pests. The openings can be arranged transversely to the flow direction of the air flow that is flowing through the flow-through space; in this way, the air flow drives the substances forcibly into the area of the openings. A single opening can be provided in the flow direction but it is also possible to arrange several openings in the flow direction behind one another in a staggered arrangement in order to increase the separation effect in this way, when this seems necessary as a function of the application. The opening can be designed as a narrow slit with which already satisfactory separation effects can be obtained. The opening can be designed such that a capillary effect is caused so that the substances, by capillary action, are sucked from the surface of the lateral wall. The openings represent a kind of trap by means of which the substances can be removed from the flow-through space.

According to one embodiment of the invention, downstream of an opening a projection is arranged by means of which substances that are gliding and/or flowing along the wall can be trapped and can be deflected through the opening into the space at the back of the wall. By a projection, the separation efficiency can be improved wherein the projection also provides a covering effect with regard to the air flow passing by. When the projection is designed such that the air flow is guided past the opening, the substances can enter more easily the opening without them being easily entrained by the air flow.

According to one embodiment of the invention, the projection is arranged on the side of the opening that is downstream in the flow direction of the air flow through the flow-through space and is oriented opposite to the air flow. With the arrangement of the projection at the downstream side and the shape that is oriented opposite to the air flow, the substances that are gliding and/or flowing along the wall are shielded in the area of the opening from the air flow that is passing by: the air flow is deflected in this area. In this way, the substances can enter easily the opening without being entrained again by the air flow.

According to one embodiment of the invention, on the back of the wall a catch basin for collecting the gliding and/or flowing substances that have been separated by the opening from the second section is arranged. By the collection of the substances separated by the opening at the back of the lateral wall, the substances must no longer be conveyed far. At the back of the lateral wall, there is also sufficient space in which the substances can be collected.

According to one embodiment of the invention, the lateral wall is entirely or at least over portions thereof coolable by a cooling device and/or heatable by a heating device. By cooling of the lateral wall, substances that are separated thereon can adhere better to the surface of the wall when the viscosity of the separated substances is temperature-dependent, as is the case, for example, for oils and grease. Depending on the dew point and evaporation point and actual temperature of the respective substance, the particles that are moved within the air flow can change their state of aggregation by the cooling effect of the lateral wall and, for example, condense thereat, or liquid substances become at least more viscous because of the cooling effect. By later heating of the lateral wall, which can be done passively by switching off the cooling action and slow heating to ambient temperature or can be done in a targeted fashion and actively by heating the lateral wall, it is possible to mobilize the substances, adhering because of cooling, in that they are now also being heated and to separate them in a targeted fashion. This can be done, for example, in that grease liquefies by being heating, flows down at the lateral wall because of gravity, and by means of a drainage line flows into a collecting container. In this way, the lateral wall by can be cleaned by brief heating. Heating of the lateral wall can also be realized without cooling.

According to one embodiment of the invention, in the air guiding passage downstream of the flow-through space rectifying flow surfaces are arranged. With these rectifying flow surfaces the helical swirl flows of the air flow exiting from the fan wheel can be converted again into a more uniform flow. Accordingly, the pipe cross-sections of the downstream venting pipes can be utilized better. Since the rectifying flow surfaces are arranged downstream of the flow-through space, the speed loss that is imparted by the rectifying action does not have a negative effect on the separation efficiency in the flow-through space.

According to one embodiment of the invention, the flow-through space is designed so as to extend in annular shape about the fan wheel. The flow-through space however must not mandatorily be round and annular; it is also possible to employ geometries with 4, 5, 6 or more outer corners or uniform or non-uniform geometries.

According to one embodiment of the invention, the fan wheel and/or the lateral wall are connected with the air extraction device by a connection that can be released without requiring a tool. Since the particles moved within the air flow adhere to the lateral wall but also on the fan wheel, it is advantageous when at least one or also both components can be removed quickly and easily from the air extraction device in order to clean them. A connection that can be released without requiring a tool can be, for example, realized by means of clamping or snap-on connecting technique or by comparable solutions.

According to one embodiment of the invention, the lateral wall extends in the axial direction to an area behind the fan wheel and in this area at least one opening is provided in the lateral wall. Because of the deflection of the air flow exiting from the fan wheel, the air flow does not continue to flow in axial direction but the flow direction is imparted with a displacement in axial direction. In order to be able to fully utilize in this case the separation effect of the lateral wall, it is expedient to extend it to an area behind the fan wheel. Inasmuch as there are still particles adhering here, it is expedient to separate these by means of an opening.

According to one embodiment of the invention, the opening is designed as a circumferential slot, in particular as an annular circumferential slot. An annular circumferential slot can be, for example, designed in a simple way by an enlarged joint between different components, for example, a joint between the lateral wall and a connecting component.

According to one embodiment of the invention, the form of the lateral wall is matched to the course of the flow of the air flow through the flow-through space and widens in flow direction of the air flow.

According to one embodiment of the invention, the air extraction device is insertable as a pipe venting module into an existing venting device. As a module, the air extraction device can be mass-produced in large numbers with corresponding cost advantages. The air extraction device can be used as a technical component in range hoods. The manufacturers of the range hoods can order the air extraction device as a single technical venting component from the distributor and can concentrate on matching the exterior components of the range hoods to their design concepts. As a module, the air extraction device can also be used in any type of venting lines, for example, in industrial or manufacturing facilities.

According to one embodiment of the invention, the vanes have a design by means of which the air flow at the exit from the fan wheel exits in radial direction out of the outflow openings and is directed through the flow-through space onto the lateral wall. When the air flow exits in radial direction from the respective outflow openings, it can reach on the shortest possible path without significant speed loss the lateral wall. In case of a slanted outflow direction of the air flow, the travel path of the air flow becomes longer and, upon reaching the lateral wall, it is significantly slower than when impinging from a radial outflow direction. At a higher flow speed the separation and removal of the particles moved within the air flow at the lateral wall works better than at lower flow speeds so that the higher flow speed of the air flow is noticeable in improved separation results. Since the outflow direction of the air flow from the outflow openings changes upon change of the rotational speed of the fan wheel, the course, the curvature, and the design of the vanes should be matched to at least one operating speed of the fan wheel such that the outflow of the air flow from the fan wheel in radial direction is perpendicular to the sidewall.

It is expressly noted that the afore described advantageous embodiments each individually combined with the features of the independent claim but also in any combination with each other.

Further modifications and preferred embodiments of the invention result from the following subject matter description and the drawings. The invention will be explained in the following with the aid of one embodiment in more detail.

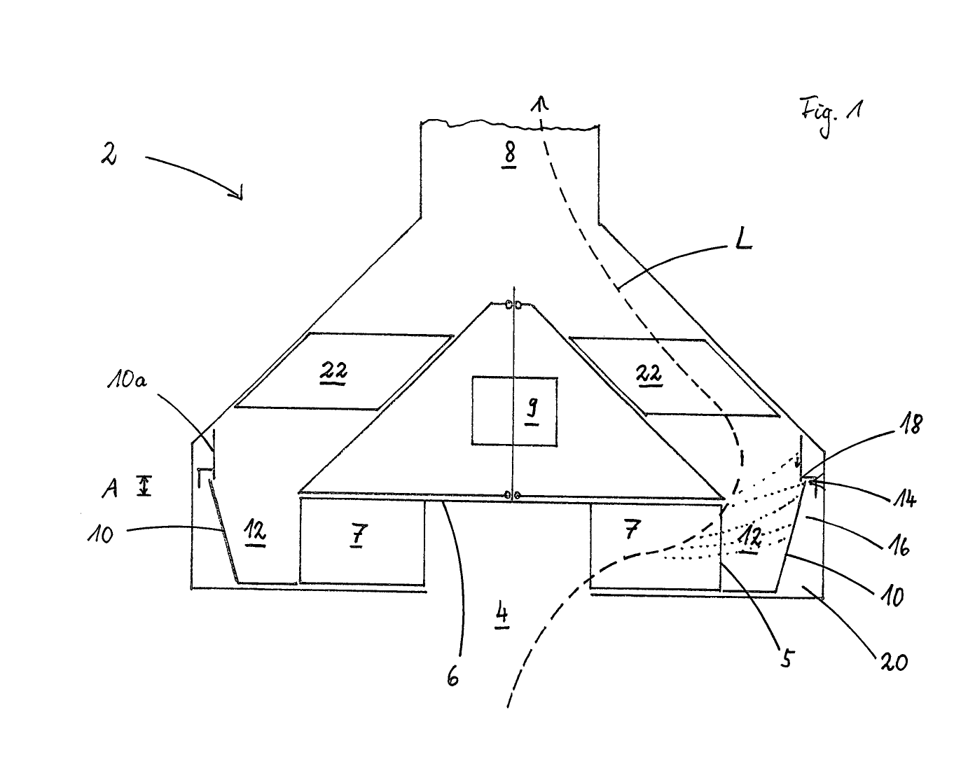

FIG. 1 shows a schematic cross-section view of the air extraction device 2 through which an air flow L flows through an air guiding passage that is formed within the air extraction device 2. In a first section, the air guiding passage extends, beginning at an intake opening 4, through a fan wheel 6 that is drivable by a motor 9. The fan wheel 6 is provided with a number of vanes 7. Because of the rotational movement of the fan wheel 6, the air flow L in the intermediate space between the vanes 7 is accelerated in a radial direction outwardly and reaches upon exiting from the fan wheel 6 its highest speed. The edges of neighboring vanes 7 positioned at the rear when viewed in the flow direction each delimit laterally an outflow opening 5 through which the air flow L exits from the fan wheel 6.

The flow-through space 12 directly adjoins the outflow opening 5 as a component of the second section of the air guiding passage. The flow-through space 12 is delimited upstream by the outflow openings 5 and in radial direction outwardly by the lateral wall 10 that is positioned at a spacing relative the outflow openings 5. The lateral wall 10 is positioned opposite to the outflow openings 5 at a sufficient spacing. The lateral wall 10 is positioned in the embodiment also in a horizontal plane relative to the fan wheel 6 at the level of the outflow openings 5 of the fan wheel 6. In the downstream direction the flow-through space 12 is open so that the air flow L can pass through unhindered. In the flow-through space 12 there are no air guiding devices by means of which the air flow L could be slowed down or deflected. Accordingly, the air flow L can exit at highest possible speed from the fan wheel 6 and enter the flow-through space 12 in which the air flow L is then deflected into a more axial flow direction relative to the axis of rotation of the fan wheel 6. The directional information “radial” and “axial” are not to be understood as precise but only as approximate directional information that may be observed precisely or at least approximately. The deflection of the flow direction of the air flow L in the flow-through space 12 is in particular affected by the course of the air guiding passage that adjoins the flow-through space 12. The directional deflection in the flow-through space 12 is however also affected by the lateral wall 10. Since the wall is located at the level of the outflow openings 5 and at a spacing thereto and extends in transverse direction to the air flow L, the air flow L is also deflected within the flow-through space 12.

In FIG. 1 the air flow L is indicated by a dashed line. In the area of the flow-through space 12 by means of dotted lines it is indicated how the trajectory of the particles moved in the air flow extends in the flow-through space 12. Based on the dotted lines that indicate the possible trajectories of the particles, it can be seen that the particles do not follow the sharp deflection of the air flow L within the flow-through space 12. The trajectories of the particles have a more or less strongly curved arc-shaped course, but as a result of the greater radius of the trajectories of the particles they impinge on the lateral wall 10 and adhere thereat on the surface. In this way, the particles are separated from the air flow L.

In the cross-sectional view of FIG. 1 it can be seen that, viewed in the flow direction, at the end of the lateral wall 10 an opening 14 is provided through which substances that are gliding and/or flowing along the lateral wall 10 can reach the back 16 of the wall 10. By removing the corresponding substances from the flow-through space 12, they can no longer be mixed again with the air flow L and entrained by it. In the embodiment illustrated in FIG. 1, the opening 14, viewed in axial direction relative to the axis of rotation of the fan wheel 6 in the flow direction of the air flow L, is positioned in an area displaced behind the fan wheel 6, wherein the spacing between the fan wheel 6 and the opening 14 in the illustrated embodiment corresponds to the spacing A. The lateral wall 10 is also extended by the spacing A in axial direction up to the area behind the fan wheel 6. In the embodiment, between the lateral wall 10 and the lateral wall 10a there is only a single opening 14 provided that may extend annularly in circumferential direction; however, it is also possible to provide several openings 14.

In the embodiment, a projection 18 is shown that projects by a suitable size past the surface of the neighboring lateral wall 10. By this projection 18, the air flow L is deflected away from the opening 14. Droplets of particles that reach the opening 14 are therefore protected by the projection 18 from being entrained by the air flow L. The particles that reach the opening 14 can in this way reach the back 16 of lateral wall 10 and drip into a catch basin 20.

Inasmuch as particles are separated in the area of the lateral wall 10a, the particles separated thereat, following the force of gravity, can flow down to the projection 18 on the lateral wall 10a. At the projection 18 the particles that are thus running down can also reach the area of the opening 14 and in this way can be removed from the flow-through space 12. The particles running down on the lateral wall 10a are indicated by a small arrow.

Downstream behind the flow-through space 12 in the air guiding passage there are rectifying flow surfaces 22 by means of which the air flow L is made more uniform.

The cross-section view of the air extraction device shown in FIG. 1 can relate to a device with a circular basic shape. In this case it is advantageous when the flow-through space 12 is designed to extend annularly in circumferential direction about the fan wheel 6. In deviation from this embodiment, it is also possible to design the air extraction devices according to the invention to be rectangular or in another way with respect to its basic shape. For a circumferentially extending ring shape of the flow-through space 12, particularly uniform flow conditions within the flow-through space 12 will be present however because of the circular shape of the fan wheel; also the corresponding air extraction devices 2 with a circular basic shape also have at different rotational speeds of the motor 9 a relatively large range in which uniform separation efficiencies can be achieved.

In the embodiment illustrated in FIG. 1 it can be seen that the shape of the lateral wall 10 is matched to the flow course of the air flow L through the flow-through space 12. Since the air flow L in the flow-through space 12 has an arc-shaped course toward the blow-out opening 8, the flow-through space 12 can be designed to be more narrow in the lower area than in the upper area. Because of the slanted wall extension of the lateral wall 10, the lateral wall widens in the flow direction of the air flow L; the free cross-section of the flow-through space 12 through which the air flow L can pass increases in downstream direction.

The invention is not limited to the afore described embodiment that serves only in an exemplary fashion for describing the invention. A person of skill in the art will have no difficulties in adapting the afore described embodiment to a concrete application situation by appropriate modifications in a way suitable to him.

What is claimed is:

1-16. (canceled)

17. An air extraction device comprising:
an intake opening;
a blow-out opening;
an air guiding passage adapted to guide an air flow in a flow direction from the intake opening to the blow-out opening;
a rotatingly drivable fan wheel having outflow openings;
wherein the air guiding passage comprises a first section and a second section;
wherein the first section adjoins the intake opening and extends through the fan wheel in a radial direction outwardly;
wherein the second section adjoins the outflow openings of the fan wheel and causes a deflection of the air flow in an approximately axial direction relative to the fan wheel and ends at the blow-out opening;
wherein the second section has a lateral wall positioned at a spacing opposite to the outflow openings of the fan wheel;
wherein the second section comprises a flow-through space that is arranged in a rotational plane of the fan wheel adjacent to the outflow openings of the fan wheel;
wherein the flow-through space is delimited in the radial direction by the lateral wall; and
no air guiding devices are arranged in the flow-through space.

18. The air extraction device according to claim 17, wherein the flow-through space adjoins immediately the outflow openings.

19. The air extraction device according to claim 17, wherein the lateral wall has one or several openings through which substances that are gliding and/or flowing along the lateral wall reach a space at a back of the lateral wall.

20. The air extraction device according to claim 19, further comprising a projection disposed downstream of the one or several openings, wherein the projection collects the substances that are gliding and/or flowing along the lateral wall and deflects the substances that are gliding and/or flowing along the lateral wall through the one or several openings into the space at the back of the lateral wall.

21. The air extraction device according to claim 20, wherein the projection is arranged on the side of the one or several openings that is positioned downstream in the flow direction of the air flow through the flow-through space and the projection is oriented opposite to the flow direction of the air flow.

22. The air extraction device according to claim 17, further comprising a catch basin arranged on the back of the lateral wall and adapted to collect the gliding and/or flowing substances that have reached through the one or several openings the space at the back of the lateral wall.

23. The air extraction device according to claim 17, wherein the lateral wall is entirely or at least over portions thereof coolable by a cooling device and heatable by a heating device.

24. The air extraction device according to claim 17, wherein the lateral wall is entirely or at least over portions thereof coolable by a cooling device or heatable by a heating device.

25. The air extraction device according to claim 17, further comprising rectifying flow surfaces arranged in the air guiding passage downstream of the flow-through space in the flow direction of the air flow.

26. The air extraction device according to claim 17, wherein the flow-through space extends annularly in a circumferential direction about the fan wheel.

27. The air extraction device according to claim 17, wherein the fan wheel and the lateral wall are attached in the air extraction device by a connection that can be released without requiring a tool.

28. The air extraction device according to claim 17, wherein the fan wheel or the lateral wall are attached in the air extraction device by a connection that can be released without requiring a tool.

29. The air extraction device according to claim 17, wherein the lateral wall in the axial direction extends into an area disposed behind the fan wheel and at least one opening is present in the lateral wall in said area.

30. The air extraction device according to claim 29, wherein the at least one opening is a circumferentially extending slot.

31. The air extraction device according to claim 17, wherein the lateral wall has a shape that is matched to a flow course of the air flow through the flow-through space and widens in the flow direction of the air flow.

32. The air extraction device according to claim 17, adapted to be inserted as a pipe venting module into an existing venting device.

33. The air extraction device according to claim 17, wherein the fan wheel has vanes that are adapted to guide the air flow, as the air flow exits from the fan wheel, in the radial direction away from the outflow openings and to direct the air flow through the flow-through space toward the lateral wall.

34. A method for separating particles moved within an air flow, the method comprising the steps of:
conveying and accelerating an air flow by a fan wheel so that the air flow exits from outflow openings of the fan wheel in a radial direction;
deflecting the airflow in an axial direction in a flow-through space that adjoins immediately the outflow openings, wherein the flow through space in the radial direction is delimited by a lateral wall and has no air guiding devices arranged therein.
